(19) United States
(12) Patent Application Publication
(10) Pub. No.: US 2014/0049566 A1
(43) Pub. Date: Feb. 20, 2014

(54) IMAGE PROCESSING APPARATUS, IMAGE PROCESSING METHOD, AND PROGRAM

(71) Applicant: SONY CORPORATION, Tokyo (JP)

(72) Inventor: NOBUYUKI SUDOU, Tokyo (JP)

(73) Assignee: SONY CORPORATION, Tokyo (JP)

(21) Appl. No.: 13/960,085

(22) Filed: Aug. 6, 2013

(30) Foreign Application Priority Data
Aug. 17, 2012 (JP) 2012-180833

(51) Int. Cl. G09G 5/38

(52) U.S. Cl. CPC G09G 5/38
USPC 345/681

(57) ABSTRACT

According to the present disclosure, an image processing apparatus is provided, which includes a control unit that extracts a still image portion from an input image and changes the still image portion.

### TECHNICAL FIELD

The present disclosure relates to an image processing apparatus, an image processing method, and a program.

### BACKGROUND ART

Patent Literatures 1 and 2 disclose a technology in which a whole displayed image is moved within a display screen of a display in order to prevent burn-in of the display.

### CITATION LIST

### Patent Literature

[PTL 1] JP 2007-304318 A
[PTL 2] JP 2005-49784 A

### SUMMARY

### Technical Problem

However, since the whole displayed image is moved in the above-described technology, the user feels annoyance at the time of visual recognition. Therefore, a technology capable of reducing the annoyance that the user feels and reducing the burn-in of the display has been sought.

### Solution to Problem

According to the present disclosure, an image processing apparatus is provided, which includes a control unit configured to extract a still image portion from an input image, and to change the still image portion.

According to the present disclosure, an image processing method is provided, which includes extracting a still image portion from an input image, and changing the still image portion.

According to the present disclosure, a program is provided, which causes a computer to realize a control function to extract a still image portion from an input image, and to change the still image portion.

According to the present disclosure, a still image portion can be extracted from an input image and can be changed.

### Advantageous Effects of Invention

As described above, according to the present disclosure, the image processing apparatus is capable of displaying the input image in which the still image portion has been changed on the display. Accordingly, the image processing apparatus can change the still image portion after fixing the display position of the whole displayed image, thereby reducing the annoyance that the user feels and the burn-in of the display.

### BRIEF DESCRIPTION OF DRAWINGS

FIG. 1 is an explanatory diagram illustrating an example of an input image to be input to an image processing apparatus according to an embodiment of the present disclosure.

FIG. 2 is an explanatory diagram illustrating an example of an input image to be input to the image processing apparatus according to the embodiment of the present disclosure.

FIG. 3 is an explanatory diagram illustrating an example of an input image to be input to the image processing apparatus according to the embodiment of the present disclosure.

FIG. 4 is an explanatory diagram illustrating an example of processing by the image processing apparatus.

FIG. 5 is an explanatory diagram illustrating an example of processing by the image processing apparatus.

FIG. 6 is a block diagram illustrating a configuration of the image processing apparatus.

FIG. 7 is a flowchart illustrating a procedure of the processing by the image processing apparatus.

FIG. 8 is an explanatory diagram illustrating an example of an input image to be input to the image processing apparatus.

FIG. 9 is an explanatory diagram illustrating an example of the processing by the image processing apparatus.

FIG. 10 is an explanatory diagram illustrating an example of the processing by the image processing apparatus.

FIG. 11 is an explanatory diagram illustrating an example of the processing by the image processing apparatus.

FIG. 12 is an explanatory diagram illustrating an example of the processing by the image processing apparatus.

FIG. 13 is an explanatory diagram illustrating an example of the processing by the image processing apparatus.

### DESCRIPTION OF EMBODIMENTS

Favorable embodiments of the present discloser will be herein described in detail with reference to the appended drawings. Note that configuration elements having substantially the same functions are denoted with the same reference signs so that overlapped description thereof is omitted.

Note that the description will be given in the following order:

1. Study of background art
2. An outline of processing by an image processing apparatus
3. A configuration of the image processing apparatus
4. A procedure of the processing by the image processing apparatus

### <1. Study of Background Art>

The inventor has arrived at an image processing apparatus 10 according to the present embodiment by studying the background art. Therefore, first, the study carried out by the inventor will be described.

Self-light emitting type display devices, such as a cathode-ray tube (CRT), a plasma display panel (PDP), and an organic light emitting display (OLED) are superior to liquid crystal display devices that require backlight in moving image properties, viewing angle properties, color reproducibility, and the like. However, when a still image is displayed for a long time, an element that displays the still image continues to emit light in the same color, and thus, the light emission properties may be deteriorated. Further, the element having the deteriorated light emission properties may display a previous image like an after image when the image is switched. This phenomenon is called burn-in. The larger the luminance (contrast) of the still image, the easily the burn-in occurs.

To prevent/reduce the burn-in, a method has been proposed, which disperses pixels emitting light by moving a whole display screen by several pixels as time advances, and makes the boundary of the burn-in of a still image less noticeable.

For example, Patent Literature 1 discloses a method of moving a display position of a whole screen in consideration of the light emission properties of an OLED. Patent Literature 2 discloses a method of obtaining a direction into which a whole image is moved from a motion vector of a moving image. That is, Patent Literatures 1 and 2 disclose a technology of moving the whole displayed image within the display screen in order to prevent the burn-in of the display.

However, in this technology, the whole displayed image is moved. Further, when the displayed image is moved, an external portion of the displayed image, i.e., the width of a black frame is changed. Therefore, the user easily recognizes that the display position of the displayed image has been changed. Therefore, the user is annoyed by the movement of the displayed image. Further, to display the whole displayed image even if it is moved side to side and up and down, it is necessary to increase the number of pixels of display devices more than the pixel number of the displayed image.

Therefore, the inventor has diligently studied the above-described background art, and has arrived at the image processing apparatus 10 according to the present embodiment. The image processing apparatus 10, schematically speaking, extracts a still image portion from an input image, and changes the still image portion (for example, moves the still image portion, changes the display magnification, and the like). The image processing apparatus 10 then displays the input image on a display as a displayed image. Accordingly, the image processing apparatus 10 can change the still image portion after fixing the display position of the whole displayed image, thereby reducing the annoyance that the user feels and the burn-in of the display. Further, the pixel number of the display may just be a similar extent to that of the displayed image. Therefore, the image processing apparatus 10 can reduce the pixel number of the display.

### <2. An Outline of Processing by an Image Processing Apparatus>

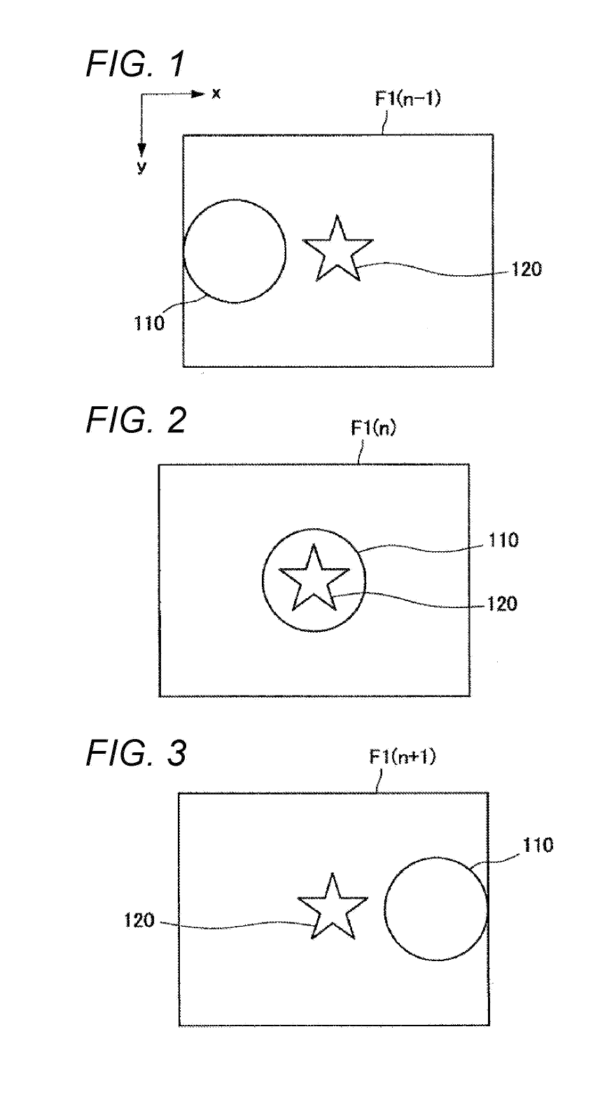

Next, an outline of processing by the image processing apparatus 10 will be described with reference to FIGS. 1 to 5. FIGS. 1 to 3 illustrate examples of an input image to be input to the image processing apparatus 10. In these examples, an input image F1(n−1) of an (n−1)th frame, an input image F1(n) of an n-th frame, and an input image F1(n+1) of an (n+1)th frame that configure the same scene are sequentially input to the image processing apparatus 10 (n is an integer). Note that, in the present embodiment, pixels that configure each input image have xy coordinates. An x-axis is an axis extending in the lateral direction in FIG. 1, and an y-axis is an axis extending in the vertical direction. In the present embodiment, while simple images (star-shaped image, and the like) are drawn as the input image used for description of the processing, more complicated images (a telop and the like) are of course applicable to the present embodiment.

A round shape image 110 and a star shape image 120 are drawn in the input images F1(n−1), the F1(n), and the F1(n+1) (hereinafter, these input images are collectively referred to as an “input image F1”). Since the display position of the star shape image 120 is fixed in each frame, it behaves as a still image portion, while the display position of the round shape image 110 is moved in each frame (moved from the left end to the right end), and thus behaves as a moving image portion. If the star shape image 120 is displayed at the same display position for a long time, there is a possibility of causing the burn-in at the display position of the star shape image 120. The higher the luminance of the star shape image 120, the more increased the possibility of occurrence of the burn-in.

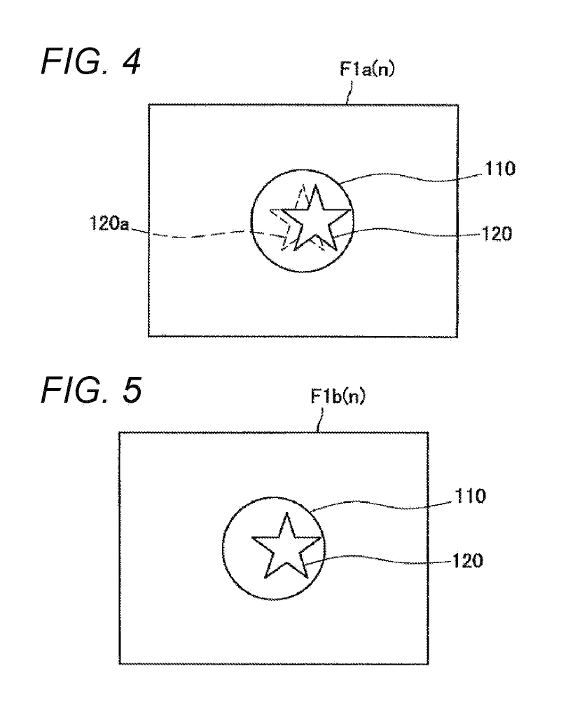

Therefore, the image processing apparatus 10 changes the star shape image 120. To be specific, as illustrated in FIGS. 2 and 4, the image processing apparatus 10 moves the display position of the star shape image 120 in the input image F1(n) (performs, so called, “orbit processing”) to generate a still interpolation image F1a(n). Here, the moving direction is the same direction as or an opposite direction to the moving image portion that configures a peripheral region of the round shape image 110, here, a motion vector of the round shape image 110. Further, while the movement amount is equal to an absolute value of the motion vector, the movement amount may be different from the absolute value.

Here, in the still interpolation image F1a(n), a blank portion 120a is formed due to the movement of the star shape image 120. The blank portion 120a is formed in a portion that does not overlap with a display region of the star shape image 120 in the still interpolation image F1a(n) in the display region of the star shape image 120 in the input image F1(n).

Therefore, the image processing apparatus 10 interpolates the blank portion 120a. To be specific, the image processing apparatus 10 extracts a blank-corresponding portion corresponding to the blank portion 120a from the input images F1(n−1) and F1(n+1) that are preceding and subsequent frames. To be more specific, the image processing apparatus 10 extracts the blank-corresponding portion from the input image F1(n−1) as the preceding frame when it is desired to move the star shape image 120 in the same direction as the motion vector of the round shape image 110. Meanwhile, the image processing apparatus 10 extracts the blank corresponding portion from the input image F1(n+1) as the subsequent frame when it is desired to move the star shape image 120 in the opposite direction to the motion vector of the round shape image 110. Then, as illustrated in FIG. 5, the image processing apparatus 10 generates a composite image F1b(n) by superimposing the extracted region on the blank portion 120a. The image processing apparatus 10 then displays the composite image F1b(n) as an input image of the n-th frame in place of the input image F1(n).

Accordingly, the image processing apparatus 10 can change the star shape image 120 (in this example, can moves the star shape image 120 by several pixels), thereby suppressing the deterioration of an element that displays the star shape image 120, resulting in reduction of the burn-in of the display. In addition, since it is not necessary for the image processing apparatus 10 to move the display position of the whole displayed image, the annoyance that the user feels can be reduced. In addition, since the pixel number of the display may just be a similar extent to the pixel number of the displayed image, the image processing apparatus 10 can reduce the pixel number of the display. Note that, while, in this example, only the star shape image 120 of the input image F1(n) of the n-th frame is adjusted, input images of other frames may also be similarly adjusted. Further, while the star shape image 120 is moved in the right direction in FIG. 4, the star shape image 120 may be moved in the left direction.

### <3. A Configuration of the Image Processing Apparatus>

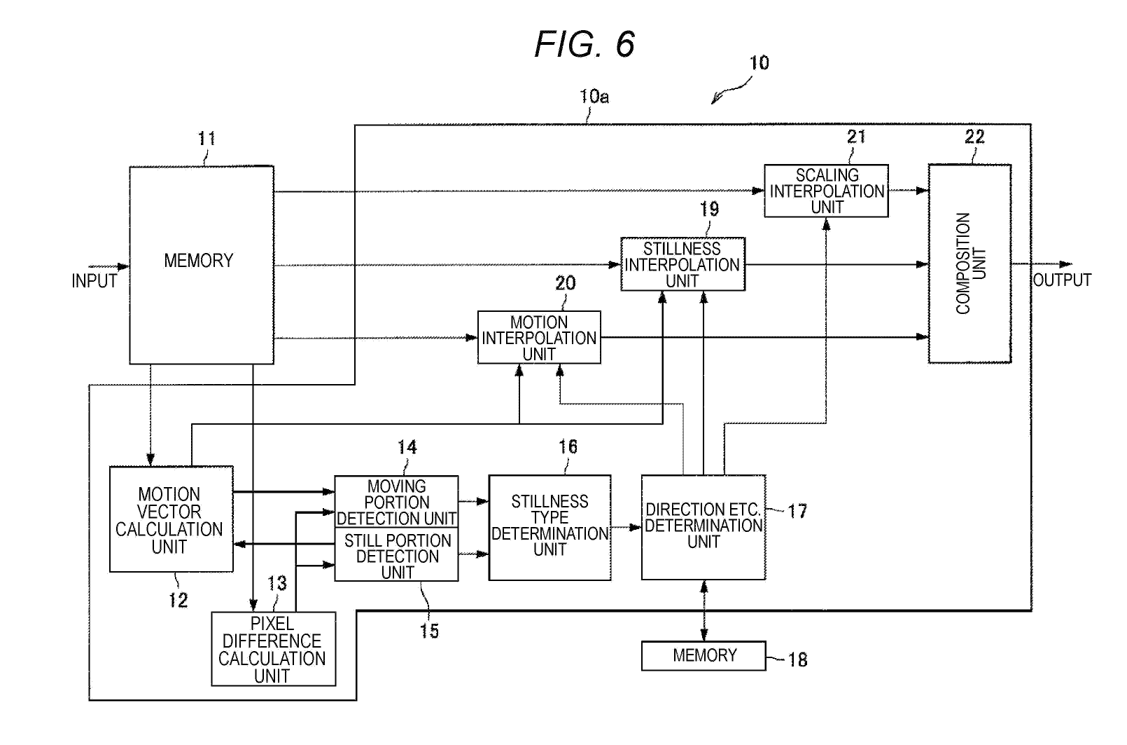

Next, a configuration of the image processing apparatus 10 will be described based on the block diagram illustrated in FIG. 6. The image processing apparatus 10 includes memories 11 and 18 and a control unit 10a. The control unit 10a includes a motion vector calculation unit 12, a pixel difference calculation unit 13, a moving portion detection unit 14, a still portion detection unit 15, a stillness type determination unit 16, and a direction etc. determination unit 17. Further, the control unit 10a includes a stillness interpolation unit 19, a motion interpolation unit 20, a scaling interpolation unit 21, and a composition unit 22.

Note that the image processing apparatus 10 includes hardware configurations including a CPU, a ROM, a RAM, a hard disk, and the like. A program that allows the image processing apparatus 10 to realize the control unit 10a is stored in the ROM. The CPU reads out the program recorded in the ROM and executes the program. Therefore, these hardware configurations realize the control unit 10a. Note that, in the present embodiment, the “preceding frame” means one frame before a current frame, and the “subsequent frame” means one frame after the current frame. That is, the control unit 10a detects the blank corresponding portion from the one preceding and one subsequent frames. However, the control unit 10a may extract the blank corresponding portion from further preceding (or further subsequent) frames.

The memory 11 also serves as a frame memory, and stores an input image having at least two or more fields, or two or more frames. The motion vector calculation unit 12 acquires an input image of the current frame and an input image of the preceding frame from the memory 11. Further, the motion vector calculation unit 12 acquires still image portion information from the still portion detection unit 15. Here, the still image portion information indicates pixels that configure a still image portion.

Then, the motion vector calculation unit 12 calculates a motion vector of the input image of the current frame in a unit of block based on the information. That is, the motion vector calculation unit 12 excludes a still image portion from the current frame, and divides a region other than the still image portion into a plurality of blocks. Here, the motion vector calculation unit 12 divides a peripheral region of the still image portion into a first block and a region other than the peripheral region (i.e., a separated region) into a second block. The first block is smaller than the second block. That is, while detecting a motion of the peripheral region of the still image portion in detail, the motion vector calculation unit 12 roughly detects a motion of the other region compared with the peripheral region. As described below, this is because the peripheral region of the still image portion is a region necessary for the interpolation of the blank portion. Although the sizes of the first and second blocks are not particularly limited, the first block has, for example, the size of 2×2 pixels, and the second block has the size of 16×16 pixels. The size of the peripheral region is also not particularly limited. However, the distance between an outer edge portion of the peripheral region and the still image portion may be several pixels (for example, 5 to 6 pixels).

The motion vector calculation unit 12 then acquires motion vector information of the preceding frame from the memory 11, and matches a block of the current frame and a block of the preceding frame (performs block matching) to associate the blocks of the current frame and of the preceding frame with each other. The motion vector calculation unit 12 then calculates a motion vector of the block of the current frame based on the blocks of the current frame and of the preceding frame. The motion vector is vector information that indicates a direction and an amount of movement of each block during one frame. The block matching and the method of calculating a motion vector are not particularly limited. For example, the processing thereof is performed using a sum of absolute difference estimation (SAD) that is used for motion evaluation of a MPEG image.

The motion vector calculation unit 12 outputs the motion vector information related to the motion vector of each block to the moving portion detection unit 14, the still portion detection unit 15, the stillness interpolation unit 19, and the motion interpolation unit 20. The motion vector calculation unit 12 stores the motion vector information in the memory 11. The motion vector information stored in the memory 11 is used when a motion vector of a next frame is calculated.

The pixel difference calculation unit 13 acquires the input image of the current frame, the input image of the preceding frame, and the input image of the subsequent frame from the memory 11. The pixel difference calculation unit 13 then compares the pixels that configure the current frame and the pixels that configure the preceding and subsequent frames to extract a still image portion for each pixel.

To be specific, the pixel difference calculation unit 13 calculates a luminance differential value ΔPL of each pixel P(x, y) based on the following expression (1):

ΔPL=|P(F(n−1),x,y)+P(F(n+1),x,y)−2*P(F(n),x,y)| (1)

In the expression (1), P(F(n−1), x, y), P(F(n), x, y), and P(F(n+1), x, y) respectively represent the luminance of the pixel P(x, y) in the preceding frame, the current frame, and the subsequent frame.

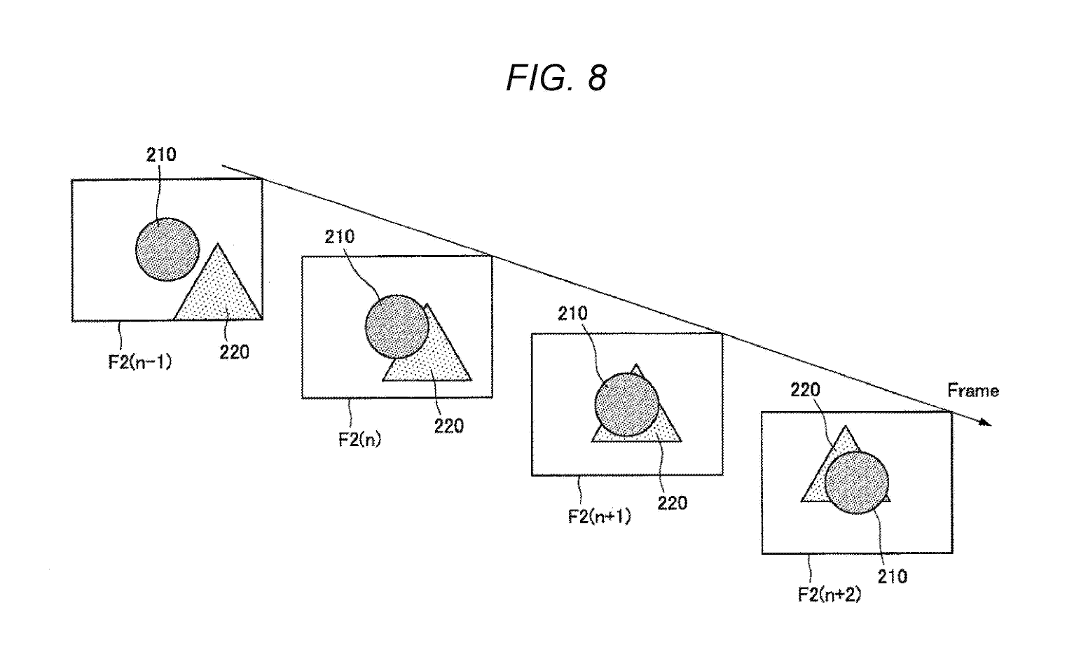

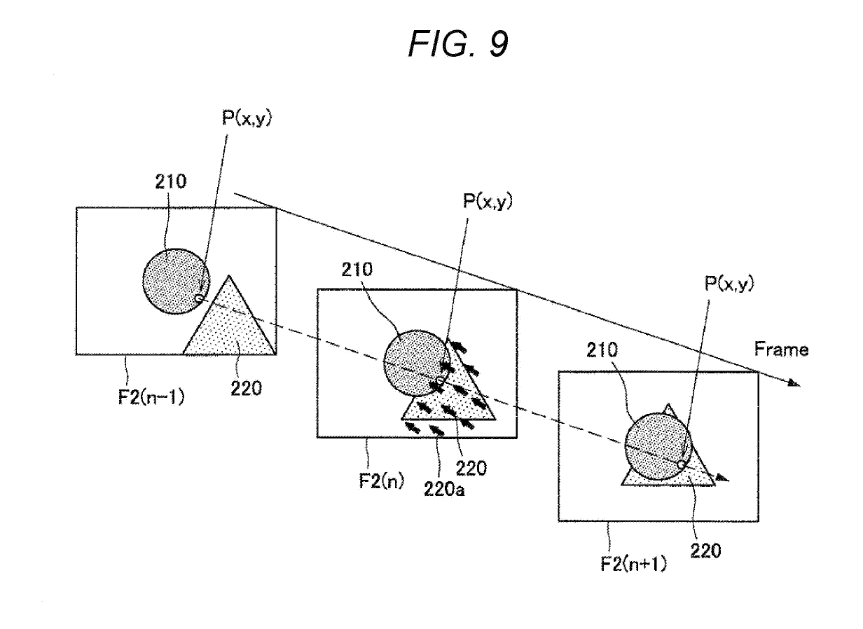

Here, a calculation example of the luminance differential value ΔPL will be described with reference to FIGS. 8 and 9. In this example, as illustrated in FIG. 8, the input images F2(n−1) to F2(n+2) of the (n−1)th to (n+2)th frames are input to the image processing apparatus 10. These input images F2(n−1) to F2(n+2) configure the same scene. In this example, since the display position of the round shape image 210 is fixed in each frame, the round shape image 210 serves as a still image portion. The display position of a triangle image 220 is moved in each frame (moved from a lower right end portion to an upper left end portion, and thus the triangle image 220 serves as a moving image portion. Arrows 220a represent a motion vector of the triangle image 220. In this example, the luminance differential value ΔPL of the pixel P(x, y) within the round shape image 210 is calculated with the above-described expression (1).

The pixel difference calculation unit 13 generates luminance differential value information related to the luminance differential value ΔPL of each pixel, and outputs the information to the moving portion detection unit 14 and the still portion detection unit 15.

Note that the processing of the pixel difference calculation unit 13 is performed for each pixel, and thus, a load of the processing is larger than that of calculation for each block. Therefore, the input image is roughly divided into a still image block and a moving image block by the motion vector calculation unit 12, and the processing of the pixel difference calculation unit 13 may be performed for the still image block.

In this case, for example, the motion vector calculation unit 12 divides the input image into blocks having the same size, and performs the block matching and the like for each block to calculate the motion vector of each block. The motion vector calculation unit 12 then outputs the motion vector information to the pixel difference calculation unit 13. When an absolute value (the magnitude) of the motion vector is less than a predetermined reference vector amount, the pixel difference calculation unit 13 recognizes a block having the motion vector as a still image block. The pixel difference calculation unit 13 then calculates the luminance differential value ΔPL of the pixel that configures the still image block, and outputs the luminance differential value information to the still portion detection unit 15. The still portion detection unit 15 generates the still image portion information by the processing described below, and outputs the information to the motion vector calculation unit 12. The motion vector calculation unit 12 sub-divides only the peripheral region of the still image portion into the first block based on the still image portion information, and performs the above-described processing for the first block. The motion vector calculation unit 12 then outputs the motion vector information to the moving portion detection unit 14, and the like. According to the processing, the pixel difference calculation unit 13 can calculate the luminance differential value ΔPL of only a portion having a high probability of becoming a still image portion from among the input images, thereby reducing the processing load.

The moving portion detection unit 14 detects a moving image portion from the input image of the current frame based on the motion vector information and the luminance differential value information. To be specific, the moving portion detection unit 14 recognizes a block including a pixel in which the luminance differential value is a predetermined reference differential value or more as the moving image portion. Further, if the absolute value (the magnitude) of a motion vector is the predetermined reference vector amount or more, the moving portion detection unit 14 recognizes a block having the motion vector as the moving image portion. The moving portion detection unit 14 then generates moving image portion information that indicates the block that serves as the moving image portion, and outputs the information to the stillness type determination unit 16.

The still portion detection unit 15 detects a still image portion from the input image of the current frame based on the luminance differential value information. To be specific, the still portion detection unit 15 recognizes a pixel in which the luminance differential value is less than the reference differential value as the still image portion. In this way, in the present embodiment, the still portion detection unit 15 detects the still image portion in a unit of pixel. Accordingly, the detection accuracy of the still image portion is improved. The still portion detection unit 15 generates still image information that indicates pixels that configure the still image portion, and outputs the information to the motion vector calculation unit 12 and the stillness type determination unit 16.

Note that examples of the still image portion include a region, a figure, a character, and the like, having given sizes. To be specific, examples of the still image portion include a logo, a figure of a clock, a telop appearing at a bottom of a screen. The still portion detection unit 15 stores the still image information in the memory 18. Further, the still portion detection unit 15 deletes the still image information in the memory 18 when there is a scene change.

The stillness type determination unit 16 determines the stillness type of the moving input image based on the moving image portion information and the still image information. Here, in the present embodiment, the stillness type is one of a “moving image”, “partial region stillness”, and “whole region stillness”.

The “moving image” indicates an input image in which the still image portion is formed into a shape other than the “partial region stillness”. In the input image of the “moving image”, the still image portion is often smaller than the moving image portion, such as a logo, a figure of a clock, and a score of a sport.

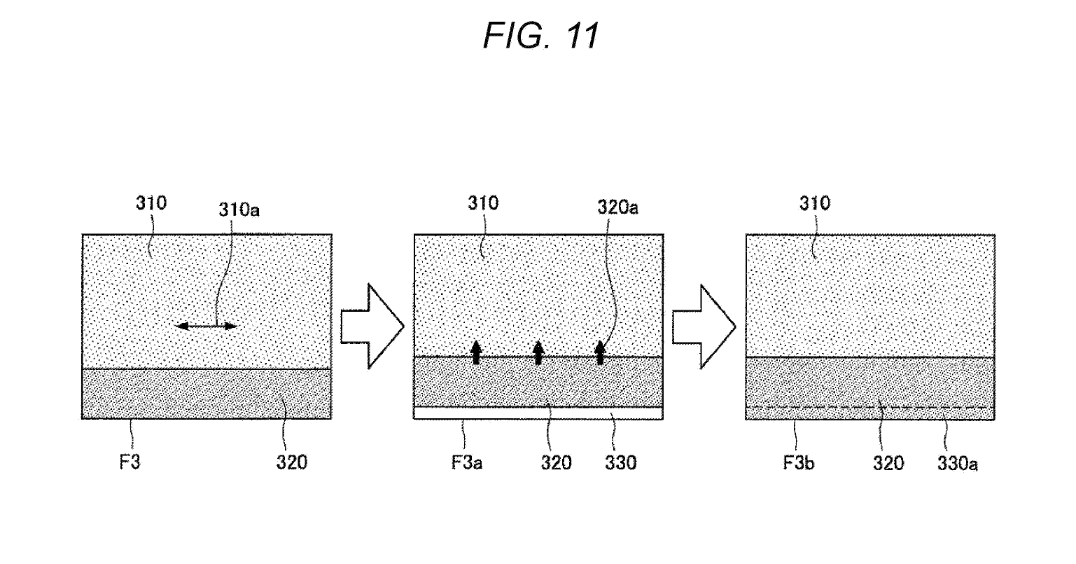

The “partial region stillness” indicates an input image in which the still image portion is formed across the length between both ends of the input image in an x direction or in an y direction. An example of the input image that serves as the “partial region stillness” is illustrated in FIG. 11. In this example, a still image portion 320 is formed across the length between the both ends in the x direction. Examples of the input image of the “partial region stillness” include an input image in which a lower portion of an image is a region for a telop and the like, and an input image in which a black belt image (or some sort of the still image portion) is formed around an image divided into the “moving image”. In these input images, the boundary between the still image portion and the moving image portion tends to be fixed, and thus the burn-in tends to occur.

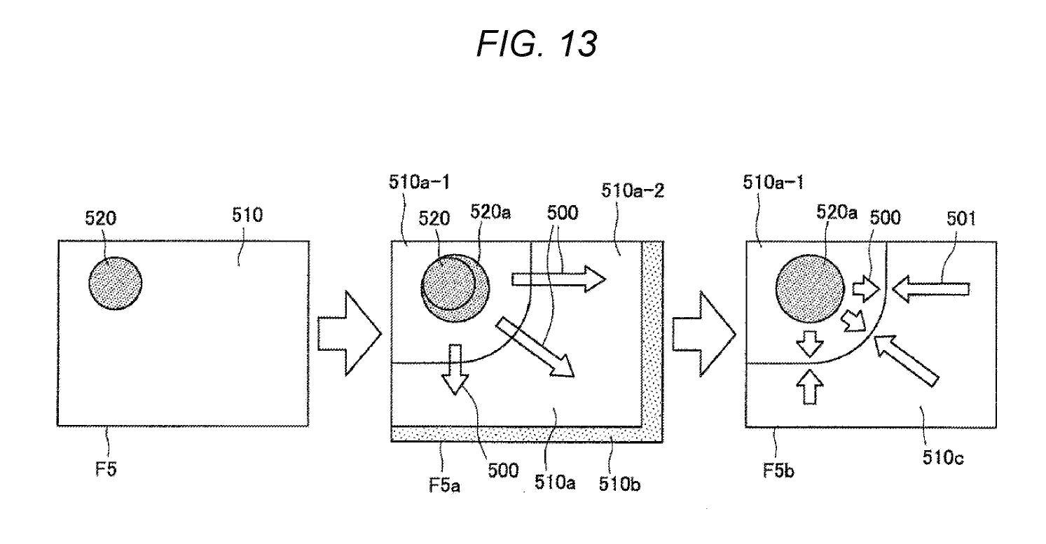

The “whole region stillness” indicates a “moving image” or “partial region stillness” in which the whole region remains still for some reasons (for example, the user has performed a pause operation). Examples of an input image of the “whole region stillness” include an image in which the whole region remain completely still, and an input image that shows a person talking in the center. Note that, when the complete stillness of the former example continues longer, the screen may be transferred to a screen-saver and the like. In the present embodiment, it is mainly assumed that a state transition between a moving image state and a still state, and repetition of such state transitions. Note that the display position of the still image portion such as a telop is the same even if the state of the input image is transferred. Therefore, the still image portion tends to be burn-in. An example of an input image that serves as the “whole region stillness” is illustrated in FIG. 13. In this example, while an input image F5 includes a still image portion 520 and a moving image portion 510, the moving image portion 510 remains still for some timings. In this case, the display position of the still image portion 520 is fixed irrespective of the state of the input image F5, and therefore, an element that displays the still image portion 520 is more likely to cause the burn-in than an element that displays the moving image portion 510.

As described above, in the present embodiment, the stillness type of the input image is divided into three types. In addition, as described below, it is necessary to change a method of changing the still image portion for each stillness type. Therefore, the stillness type determination unit 16 determines the stillness type of the input image based on the moving image portion information and the still image portion information. The stillness type determination unit 16 then outputs the stillness type information related to a judgment result to the direction etc. determination unit 17.

The direction etc. determination unit 17 determines a changing method, a changing direction, and a changed amount of the still image portion based on the stillness type information, and the like.

When the input image is the “moving image”, the direction etc. determination unit 17 determines the changing method is “move”. As described above, this is because, when the still image portion is moved, the blank portion is formed, and the blank portion can be interpolated using the blank corresponding portion of another frame. Of course, the direction etc. determination unit 17 may determine the changing method to be “change of display magnification”. In this case, similar adjustment to the “whole region stillness” described below is performed.

The direction etc. determination unit 17 determines the changing direction of the still image portion based on the motion vector of the moving image portion. That is, the direction etc. determination unit 17 extracts the motion vector of the moving image portion that configures the peripheral region of the still image portion, and calculates an arithmetic mean value of the motion vector. The direction etc. determination unit 17 then determines the changing direction of the still image portion, that is, the moving direction to be the same direction as or the opposite direction to the arithmetic mean value of the motion vector.

Here, the direction etc. determination unit 17 may acquire image deterioration information from the memory 18 and determine the moving direction based on the image deterioration information. Here, the image deterioration information indicates a value obtained by accumulating display luminance of an element for each element. A larger value indicates more frequent use of the element (in other words, the element is deteriorated). That is, the image deterioration information indicates usages of each pixel that configures the display screen of the display. From the viewpoint of suppression of the burn-in, it is favorable to cause a less deteriorated element to display the still image portion. Therefore, the direction etc. determination unit 17 refers to the image deterioration information of an element in the moving direction, and moves the still image portion in a direction where a less deteriorated pixel exists. Note that the image deterioration information may be a value other than the value of the accumulation of the display luminance. For example, the image deterioration information may be a number of displays of luminance having a predetermined value or more.

Note that the elements that display the input image of the “moving image” are evenly used because the display positions of the still image portion and the moving image portion of the input image of the “moving image” are frequently switched. Therefore, the degree of deterioration is approximately even in all elements. Meanwhile, in the “partial region stillness” described below, since a specific element continues to display the still image portion, the degree of deterioration becomes larger. Therefore, the image deterioration information is especially useful in determining the moving direction of the still image portion of the “partial region stillness”.

The direction etc. determination unit 17 determines the changed amount of the still image portion, that is, the movement amount based on the motion vector of the moving image portion. That is, the direction etc. determination unit 17 extracts the motion vector of the moving image portion that configures the peripheral region of the still image portion, and calculates the arithmetic mean value of the motion vector. The direction etc. determination unit 17 then determines the movement amount of the still image portion to be the same value as the arithmetic mean value of the motion vector. Of course, the movement amount is not limited to be above value, and may be a value less than the arithmetic mean value of the motion vector, for example. For example, the direction etc. determination unit 17 may determine the changed amount based on the image deterioration information. To be specific, the direction etc. determination unit 17 determines the changed amount to be less than the arithmetic mean value of the motion vector when the deterioration of the device can be lowered if the changed amount is less than the arithmetic mean value of the motion vector.

When the input image is the “partial region stillness”, the direction etc. determination unit 17 determines the changing method to be “move”. This is because, even in this stillness type, a blank portion is caused due to the movement of the still image portion, and this blank portion can be interpolated by the blank corresponding portion of another frame or by the still image portion of the current frame. Details will be described below.

The direction etc. determination unit 17 determines the changing direction of the still image portion, that is, the moving direction to be the x direction or the y direction. To be specific, when the still image portion is formed across the length between the both ends in the x direction, the direction etc. determination unit 17 determines the changing direction to be the y direction. Meanwhile, when the still image portion is formed across the length between both ends in the y direction, the direction etc. determination unit 17 determines the changing direction to be the x direction. The moving direction of the still image portion is a direction intersecting, the same direction as, or the opposite direction to the motion vector of the moving image portion. Note that the direction etc. determination unit 17 may determine the moving direction to be an oblique direction. In this case, the moving direction is a combination of the x direction and the y direction. When the moving direction is the oblique direction, the processing by the stillness interpolation unit 19 and the motion interpolation unit 20 described below is also a combination of the processing corresponding to the x direction and to the y direction.

Here, the direction etc. determination unit 17 may acquire the image deterioration information from the memory 18 and determine the moving direction based on the image deterioration information. That is, the direction etc. determination unit 17 refers to the image deterioration information of an element in the moving direction, and moves the still image portion into a direction where a less deteriorated element exists.

The direction etc. determination unit 17 determines the changed amount of the still image portion, that is, the movement amount based on the motion vector of the moving image portion. That is, the direction etc. determination unit 17 extracts the motion vector of the moving image portion that configures the peripheral region of the still image portion, and calculates the arithmetic mean value of the motion vector. The direction etc. determination unit 17 then determines the movement amount of the still image portion to be the same value as the arithmetic mean value of the motion vector. Of course, the movement amount is not limited to this value, and may be a value less than the arithmetic mean value of the motion vector, for example. For example, the direction etc. determination unit 17 may determine the changed amount based on the image deterioration information. To be specific, the direction etc. determination unit 17 determines the changed amount to be less than the arithmetic mean value of the motion vector when the deterioration of the element can be lowered if the changed amount is less than the arithmetic mean value of the motion vector.

Alternatively, the direction etc. determination unit 17 may determine the changed amount without considering the motion vector when moving the still image portion into the direction intersecting the motion vector, or especially, in a direction perpendicular to the motion vector. This is because, as described below, when the still image portion is moved into the direction perpendicular to the motion vector, the blank portion is interpolated by the still image portion, and therefore, it is not necessary to consider the motion vector.

When the input image is the “whole region stillness”, the direction etc. determination unit 17 determines the changing method to be the “change of display magnification”. When the input image is the “whole region stillness”, the moving image portion is also temporarily stopped. Therefore, the motion vector of the moving image portion is not accurately calculated (the motion vector temporarily becomes 0 or a value near 0). Therefore, the image processing apparatus 10 may not interpolate the blank portion caused due to the movement of the still image portion based on the motion vector. Therefore, the direction etc. determination unit 17 determines the changing method to be the “change of display magnification” when the input image is the “whole region stillness”.

The direction etc. determination unit 17 determines the changing direction and the changed amount of the still image portion, that is, an x component and an y component of the display magnification. When the x component is larger than 1, the still image portion is enlarged into the x direction, and when the value of the x component is less than 1, the still image portion is decreased in the x direction. The same applies to the y component. Here, the direction etc. determination unit 17 may acquire the image deterioration information from the memory 18 and determine the x component and the y component of the display magnification based on the image deterioration information. A specific content is similar to those of the “moving image” and the “partial region stillness”.

The direction etc. determination unit 17 outputs the changing method, the changing direction, and change information related to the changed amount to the stillness interpolation unit 19, the motion interpolation unit 20, and the scaling interpolation unit 21.

The stillness interpolation unit 19 acquires the input image of the current frame from the memory 11, and generates a still interpolation image based on the input image of the current frame and the information provided from the motion vector calculation unit 12 and the direction etc. determination unit 17.

A specific example of processing by the stillness interpolation unit 19 will be described based on FIGS. 8, and 10 to 13. First, an example of the processing performed when the input image is the “moving image” will be described. In this example, the input images F2(n−1) to F2(n+2) illustrated in FIG. 8 are input to the image processing apparatus 10. Further, the current frame is an n-th frame.

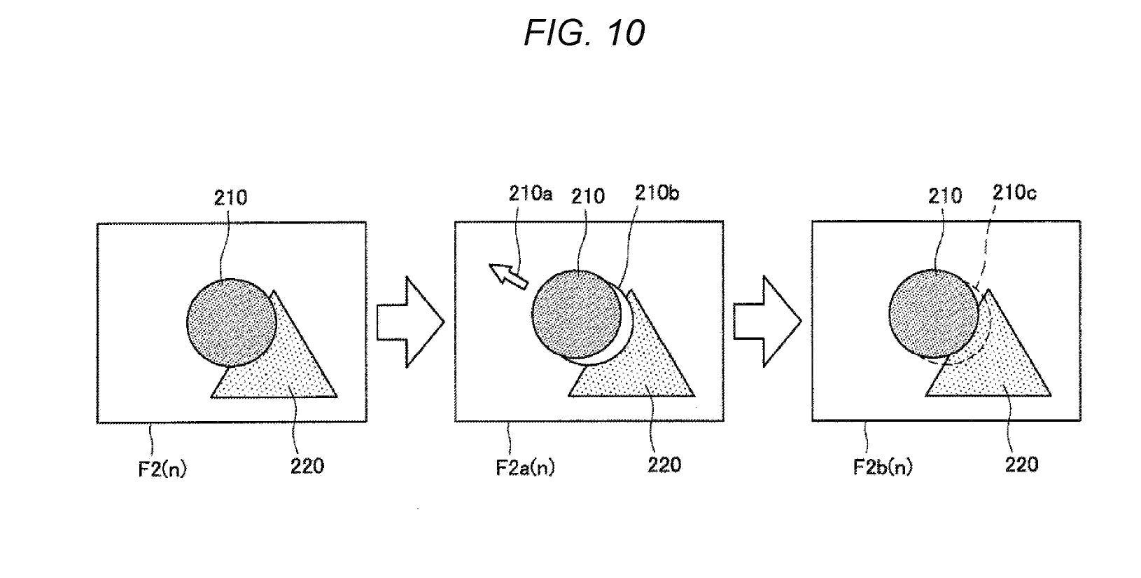

As illustrated in FIG. 10, the stillness interpolation unit 19 moves the round shape image 210 that is the still image portion of the input image F2(n) in a direction of an arrow 210a (the same direction as the motion vector of the triangle image 220) to generate a still interpolation image F2a(n). Here, the movement amount is a similar extent to the magnitude of the motion vector of the triangle image 220. Accordingly, a blank portion 210b is formed in the still interpolation image F2a(n).

Next, an example of the processing performed when the stillness type of the input image is the “partial region stillness” will be described. In this example, an input image F3 illustrated in FIG. 11 is input to the image processing apparatus 10. The input image F3 includes a moving image portion 310 and a still image portion 320. An arrow 310a indicates the motion vector of the moving image portion 310.

As illustrated in FIG. 11, the stillness interpolation unit 19 moves the still image portion 320 upward (into a direction of arrows 320a). That is, the stillness interpolation unit 19 moves the still image portion 320 into a direction perpendicular to the motion vector. Accordingly, the stillness interpolation unit 19 generates a still interpolation image F3a. A blank portion 330 is formed in the still interpolation image F3a.

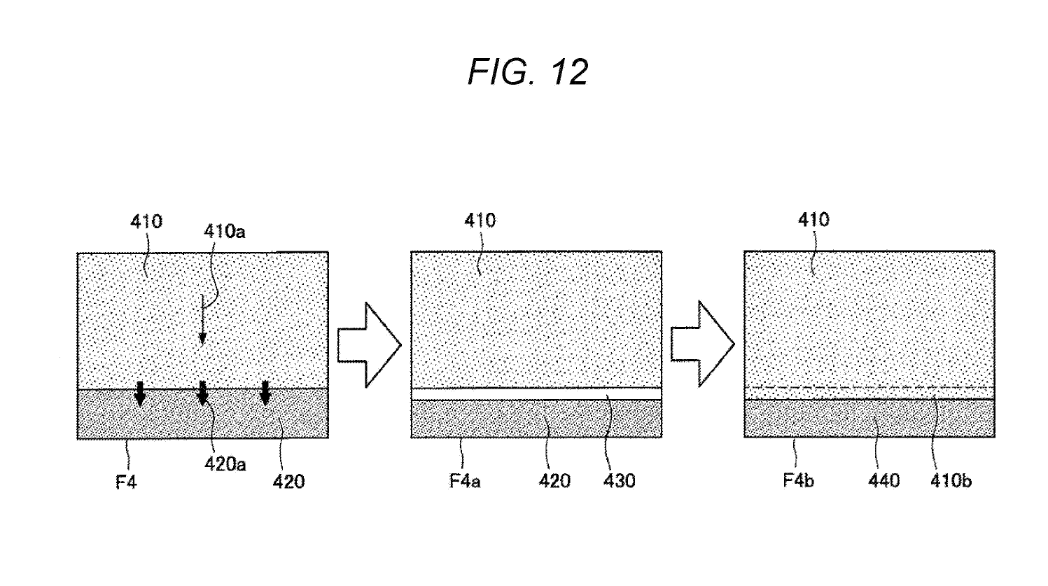

Next, another example of the processing performed when the stillness type of the input image is the “partial region stillness” will be described. In this example, an input image F4 illustrated in FIG. 12 is input to the image processing apparatus 10. The input image F4 includes a moving image portion 410 and a still image portion 420. An arrow 410a indicates the motion vector of the moving image portion 410.

As illustrated in FIG. 12, the stillness interpolation unit 19 moves the still image portion 420 downward (in a direction of arrows 420a). That is, the stillness interpolation unit 19 moves the still image portion 420 in the same direction as the motion vector. Accordingly, the stillness interpolation unit 19 generates a still interpolation image F4a. A blank portion 430 is formed in the still interpolation image F4a. Note that, since the still interpolation image F4a is enlarged due to the downward movement of the still image portion 420, the stillness interpolation unit 19 performs reduction, clipping, and the like of the still image portion 420 to uniform the size of the still interpolation image F4a and the input image F4.

Note that the stillness interpolation unit 19 may determine whether either the reduction or clipping is performed based on the properties of the still image portion 420. For example, when the still image portion 420 is a belt in a single color (for example, in black), the stillness interpolation unit 19 may perform either the reduction processing or the clipping processing. Meanwhile, when some sort of pattern (a telop, etc.,) is drawn on the still image portion 420, it is favorable that the stillness interpolation unit 19 performs the reduction processing. This is because, when the clipping processing is performed, there is a possibility that a part of the information of the still image portion 420 is lost.

Next, an example of the processing performed when the stillness type of the input image is the “whole region stillness” will be described. In this example, an input image F5 illustrated in FIG. 13 is input to the image processing apparatus 10. The input image F5 includes a moving image portion 510 and a still image portion 520. Note that the moving image portion 510 is also temporarily stopped.

As illustrated in FIG. 13, the stillness interpolation unit 19 enlarges the input image F5 into the x direction and the y direction (in the directions of arrows 500) to generate a still interpolation image F5a. Therefore, in this case, both of the x component and the y component of the display magnification are larger than 1. Accordingly, the still image portion 520 is enlarged to become an enlarged still image portion 520a, and the moving image portion 510 is enlarged to become an enlarged moving image portion 510a. Note that an outer edge portion 510b in the enlarged moving image portion 510a goes beyond the input image F5, and thus, this portion may not be displayed on the display. Therefore, as described below, the motion interpolation unit 20 performs non-linear scaling so that the outer edge portion 510b is gone. Details will be described below. The stillness interpolation unit 19 outputs a still interpolation image to the composition unit 22.

Note that, in the example illustrated in FIG. 13, the stillness interpolation unit 19 enlarges the input image F5. However, if the change information provided from the direction etc. determination unit 17 indicates the reduction of the input image, the stillness interpolation unit 19 reduces the input image F5. In this case, the still interpolation image becomes smaller than the input image. Therefore, the motion interpolation unit 20 applies the non-linear scaling to the moving image portion to enlarge the still interpolation image. Details will be described below.

The motion interpolation unit 20 acquires the input images of the current frame and the preceding and subsequent frames from the memory 11, and generates a blank corresponding portion or an adjusted moving image portion based on the input images of the current frame and the preceding and subsequent frames and the information provided from the motion vector calculation unit 12 and the direction etc. determination unit 17.

A specific example of the processing by the motion interpolation unit 20 will be described based on FIGS. 8, and 10 to 13. First, an example of the processing performed when the input image is the “moving image” will be described. In this example, the input images F2(n−1) to F2(n+2) illustrated in FIG. 8 are input to the image processing apparatus 10. Further, the current frame is the n-th frame. In this example, the round shape image 210 is moved into the same direction as the motion vector of the triangle image 220 by the stillness interpolation unit 19, and the blank portion 210b is formed.

Here, the motion interpolation unit 20 extracts a blank corresponding portion 210c corresponding to the blank portion 210b from a block that configures the input image of the preceding frame, especially, from the first block. To be specific, the motion interpolation unit 20 predicts the position of each block in the current frame based on the motion vector of each block of the preceding frame. The motion interpolation unit 20 then recognizes a block that is predicted to move into the blank portion 210b in the current frame as the blank corresponding portion 210c, from among blocks in the preceding frame. Accordingly, the motion interpolation unit 20 extracts the blank corresponding portion 210c.

Meanwhile, when the still image portion is moved in the opposite direction to the motion vector, the motion interpolation unit 20 extracts a blank corresponding portion corresponding to the blank portion from a block that configures the subsequent frame, especially from the first block. To be specific, the motion interpolation unit 20 replaces the sign of the motion vector of the subsequent frame to calculate an inverse motion vector, and estimates in which position each block of the subsequent frame existed in the current frame. The motion interpolation unit 20 then recognizes a portion estimated to exist in the black portion in the current frame as the blank corresponding portion. Accordingly, the motion interpolation unit 20 extracts the blank corresponding portion 210c.

Next, an example of the processing performed when the stillness type of the input image is the “partial region stillness” will be described. In this example, an input image F3 illustrated in FIG. 11 is input to the image processing apparatus 10. The input image F3 includes a moving image portion 310 and a still image portion 320. The arrow 310a indicates the motion vector of the moving image portion 310. Further, the still image portion 320 is moved upward (in the direction of the arrows 320a) by the stillness interpolation unit 19, and the blank portion 330 is formed.

In this case, the moving direction of the still image portion 320 is perpendicular to the motion vector, and therefore, interpolation based on the motion vector may not be performed. This is because the blank corresponding portion does not exist in the preceding and subsequent frames. Therefore, the motion interpolation unit 20 interpolates the blank portion 330 based on the still image portion 320. To be specific, the motion interpolation unit 20 enlarges the still image portion 320 to generate a blank corresponding portion 330a corresponding to the blank portion 330 (scaling processing). Further, the motion interpolation unit 20 may recognize a portion adjacent to the blank portion 330 in the still image portion 320 as the blank corresponding portion 330a (repeating processing). In this case, a part of the still image portion 320 is repeatedly displayed.

Note that the motion interpolation unit 20 may determine which processing is performed according to the properties of the still image portion 320. For example, when the still image portion 320 is a belt in a single color (for example, in black), the motion interpolation unit 20 may perform either the scaling processing or the repeating processing. Meanwhile, when some sort of pattern (a telop, etc.,) is drawn on the still image portion 320, it is favorable that the motion interpolation unit 20 performs the scaling processing. This is because, when the repeating processing is performed, the pattern of the still image portion 320 may become discontinuous in the blank corresponding portion 330a. In addition, in this example, since the still image portion 320 is superimposed on a lower end portion of the moving image portion 310, the motion interpolation unit 20 may perform reduction, clipping, and the like of the moving image portion 310.

Next, another example of the processing performed when the stillness type of the input image is the “partial region stillness” will be described. In this example, the input image F4 illustrated in FIG. 12 is input to the image processing apparatus 10. The input image F4 includes the moving image portion 410 and the still image portion 420. The arrow 410a indicates the motion vector of the moving image portion 410. Further, the still image portion 420 is moved downward (in the direction of the arrows 420a) by the stillness interpolation unit 19, and the blank portion 430 is formed.

In this example, since the moving direction of the still image portion 420 is the same direction as the motion vector, interpolation based on the motion vector becomes possible. To be specific, the interpolation similar to the example illustrated in FIG. 10 is possible. Therefore, the motion interpolation unit 20 extracts the blank corresponding portion from the input image of the preceding frame.

Next, an example of the processing performed when the stillness type of the input image is the “whole region stillness” will be described. In this example, the input image F5 illustrated in FIG. 13 is input to the image processing apparatus 10. The input image F5 includes the moving image portion 510 and the still image portion 520. However, the moving image portion 510 is also temporarily stopped. Further, the input image F5 is enlarged in the xy direction by the stillness interpolation unit 19, and the outer edge portion 510b goes beyond the input image F5.

Therefore, the motion interpolation unit 20 divides the enlarged moving image portion 510a into a peripheral region 510a-1 and an external region 510a-2 of the enlarged still image portion 520a, and reduces the external region 510a-2 (reduces in the directions of arrows 501). Accordingly, the motion interpolation unit 20 generates the adjusted moving image portion 510c. Accordingly, the motion interpolation unit 20 performs the non-linear scaling of the moving image portion 510. The composition unit 22 described below replaces the external region 510a-2 of the still interpolation image F5a with the moving image portion 510c to generate a composite image.

Note that, when the stillness interpolation unit 19 has reduced the input image F5, the motion interpolation unit 20 performs the processing of enlarging the external region 510a-2 to generate the adjusted moving image portion 510c. When a plurality of still image portion exists, the motion interpolation unit 20 can perform similar processing. That is, the motion interpolation unit 20 may just enlarge (or reduce) the peripheral region of each still image portion, and reduce (or enlarge) the region other than the peripheral region, that is, the moving image portion.

The motion interpolation unit 20 outputs moving image interpolation information related to the generated blank corresponding portion or adjusted moving image portion to the composition unit 22.

The scaling interpolation unit 21 performs the processing of interpolating the blank portion that has not been interpolated by the motion interpolation unit 20. That is, when the motion of the moving image portions of all pixels is even within the moving image portion, the blank portion is interpolated by the processing by the motion interpolation unit 20. However, the motion of the moving image portion may differ (may be disordered) in each pixel. In addition, the moving image portion may be moved in an irregular manner. That is, while the moving image portion is moved into a given direction at a certain time, the moving image may suddenly change the motion at a particular frame. In these cases, only the processing by the motion interpolation unit 20 may not completely interpolate the blank portion.

Further, when the moving image portion is moved while changing its magnification (for example, when the moving image portion is moved while being reduced), the pattern of the blank corresponding portion and the pattern around the blank portion may not be connected.

Therefore, first, the scaling interpolation unit 21 acquires the input image of the current frame from the memory 11, and further, acquires the still interpolation image and the blank corresponding portion from the stillness interpolation unit 19 and the motion interpolation unit 20. Then, the scaling interpolation unit 21 superimposes the blank corresponding portion on the blank portion to generate a composite image. Then, the scaling interpolation unit 21 determines whether a gap is formed in the blank portion. When the gap is formed, the scaling interpolation unit 21 filters and scales the blank corresponding portion to fill the gap.

Further, when the pattern of the blank corresponding portion and the pattern around the blank portion are not connected, the scaling interpolation unit 21 performs the filtering processing at the boundary between the blank corresponding portion and the peripheral portion of the blank portion to blur the boundary. Then, the scaling interpolation unit 21 outputs the composite image adjusted by the above-described processing, that is, an adjusted image to the composition unit 22.

The composition unit 22 combines the still interpolation image, the blank corresponding portion (or the adjusted moving image portion), and the adjusted image to generate a composite image. FIG. 11 illustrates a composite image F3b of the still interpolation image F3a and the blank corresponding portion 330a. Further, FIG. 12 illustrates a composite image F4b of the still interpolation image F4a and the blank corresponding portion 410b. Further, FIG. 13 illustrates a composite image F5b of the still interpolation image F5a and the adjusted moving image portion 510c. As illustrated in these examples, in the composite images, the still image portions are changed and the peripheral regions of the still image portions are adjusted in some way. The composition unit 22 outputs the composite image to, for example, the display. The display displays the composite image. Note that, since it is not necessary that the display changes the display position of the composite image, the element number of the display is a similar extent to the pixel number of the composite image.

### <4. A Procedure of the Processing by the Image Processing Apparatus>

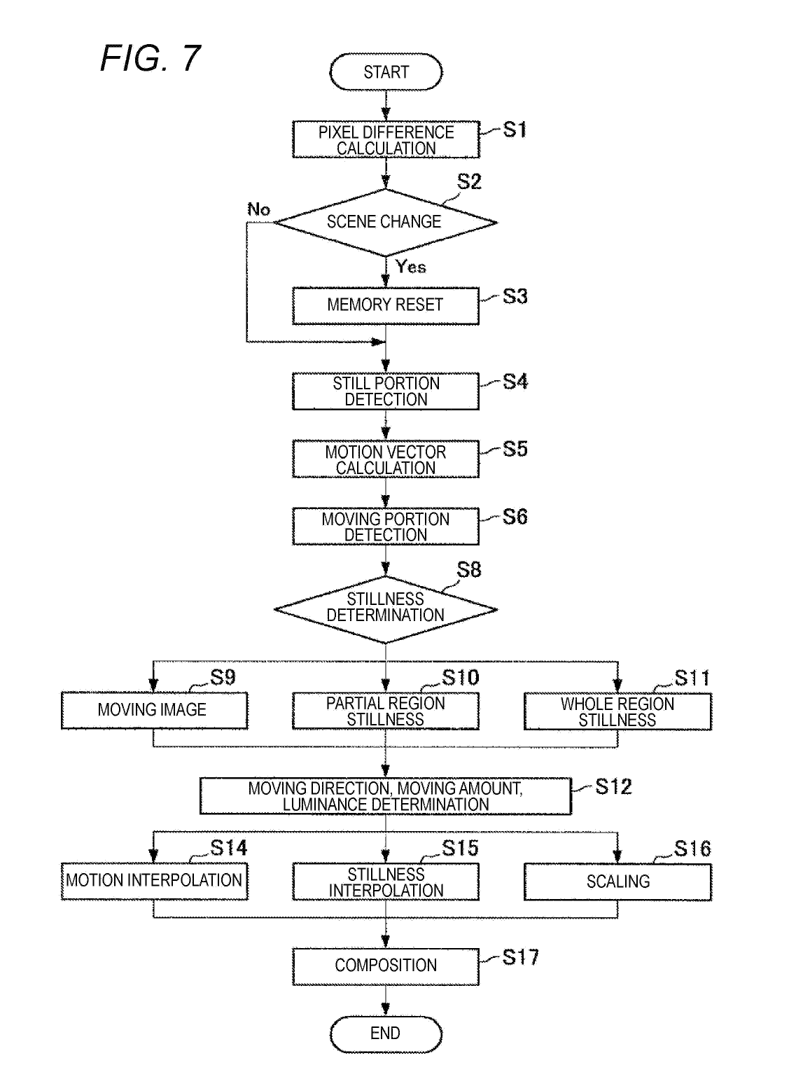

Next, a procedure of the processing by the image processing apparatus 10 will be described with reference to the flowchart illustrated in FIG. 7. Note that, as described above, in the motion vector calculation, the block of the peripheral region of the still image portion becomes small, and therefore, it is necessary to know the still image portion in advance.

Therefore, first, in step S1, the pixel difference calculation unit 13 acquires the input image of the current frame, the input image of the preceding frame, and the input image of the subsequent frame from the memory 11. Then, the pixel difference calculation unit 13 compares a pixel that configures the current frame and pixels that configure the preceding and subsequent frames to extract the still image portion for each pixel. To be specific, the pixel difference calculation unit 13 calculates the luminance differential value ΔPL of each pixel P(x, y) based on the above-described expression (1).

The pixel difference calculation unit 13 generates the luminance differential value information related to the luminance differential value ΔPL of each pixel, and outputs the information to the moving portion detection unit 14 and the still portion detection unit 15.

In step S2, the still portion detection unit 15 determines whether there is a scene change, proceeds to step S3 when there is a scene change, and proceeds to step S4 when there is no scene change. Note that whether there is a scene change may be notified from an apparatus of an output source of the input image, for example. In step S3, the still portion detection unit 15 deletes the still image information in the memory 18.

In step S4, the still portion detection unit 15 detects the still image portion (still portion) from the input image of the current frame based on the luminance differential value information. To be specific, the still portion detection unit 15 determines a pixel in which the luminance differential value is less than a predetermined reference differential value to be the still image portion. The still portion detection unit 15 generates the still image information indicating a pixel that configures the still image portion, and outputs the information to the motion vector calculation unit 12 and the stillness type determination unit 16. Note that the still portion detection unit 15 stores the still image information in the memory 18.

In step S5, the motion vector calculation unit 12 acquires the input image of the current frame and the input image of the preceding frame from the memory 11. Further, the motion vector calculation unit 12 acquires the still image portion information from the still portion detection unit 15.

The motion vector calculation unit 12 then calculates the motion vector of the input image of the current frame in a unit of block based on the information. That is, the motion vector calculation unit 12 excludes the still image portion from the current frame, and divides the region other than the still image portion into a plurality of blocks. Here, the motion vector calculation unit 12 divides the peripheral region of the still image portion into the first block and the region other than the peripheral region into the second block.

The first block is smaller than the second block. That is, while detecting the motion of the peripheral region of the still image portion in detail, the motion vector calculation unit 12 roughly detects the motion of the other region compared with the peripheral region.

The motion vector calculation unit 12 then acquires the motion vector information of the preceding frame from the memory 11, and performs the block matching, and the like to calculate the motion vector of the block of the current frame.

The motion vector calculation unit 12 outputs the motion vector information related to the motion vector of each block to the moving portion detection unit 14, the still portion detection unit 15, the stillness interpolation unit 19, and the motion interpolation unit 20. In addition, the motion vector calculation unit 12 stores the motion vector information in the memory 11. The motion vector information stored in the memory 11 is used when the motion vector of the next frame is calculated.

In step S6, the moving portion detection unit 14 detects the moving image portion (moving portion) from the input image of the current frame based on the motion vector information and the luminance differential value information. To be specific, the moving portion detection unit 14 recognizes a block including a pixel in which the luminance differential value is a predetermined reference differential value or more as the moving image portion.

Further, when the absolute value (the magnitude) of the motion vector is a predetermined reference vector amount or more, the moving portion detection unit 14 recognizes a block having the motion vector as the moving image portion. The moving portion detection unit 14 then generates the moving image portion information indicating the block that serves as the moving image portion, and outputs the information to the stillness type determination unit 16.

In step S8, the stillness type determination unit 16 determines the moving stillness type of the input image based on the moving image portion information and the still image information. Here, in the present embodiment, the stillness type is any of the “moving image”, the “partial region stillness”, and the “whole region stillness”. The stillness type determination unit 16 then outputs the stillness type information related to the judgment result to the direction etc. determination unit 17.

The direction etc. determination unit 17 determines the changing method, the changing direction, and the changed amount of the still image portion based on the stillness type information and the like.

That is, when the input image is the “moving image”, the direction etc. determination unit 17 determines the changing method to be the “move” in step S9. This is because, as described above, when the still image portion is moved, a blank portion is formed, and the blank portion can be interpolated using the blank corresponding portion of another frame.

Meanwhile, when the input image is the “partial region stillness”, the direction etc. determination unit 17 determines the changing method to be the “move” in step S10. In this stillness type, a black portion is also caused due to the movement of the still image portion, and the blank portion can be interpolated by the blank corresponding portion of another frame or the still image portion of the current frame.

Meanwhile, when the input image is the “whole region stillness”, the direction etc. determination unit 17 determines the changing method to be the “change of display magnification” in step S11. When the input image is the “whole region stillness”, the moving image portion is also temporarily stopped. Therefore, the motion vector of the moving image portion is not accurately calculated. Therefore, the image processing apparatus 10 may not interpolate the blank portion caused due to the movement of the still image portion based on the motion vector. Therefore, when the input image is the “whole region stillness”, the direction etc. determination unit 17 determines the changing method to be the “change of display magnification”.

In step S12, the direction etc. determination unit 17 determines the changing direction (moving direction), the changed amount (movement amount), and the luminance of the still image portion.

To be specific, when the input image is the “moving image”, the direction etc. determination unit 17 determines the changing direction of the still image portion based on the motion vector of the changing direction. That is, the direction etc. determination unit 17 extracts the motion vector of the moving image portion that configures the peripheral region of the still image portion, and calculates the arithmetic mean value of the motion vector. The direction etc. determination unit 17 then determines the changing direction of the still image portion, that is, the moving direction to be the same direction as or the opposite direction to the arithmetic mean value of the motion vector. Here, the direction etc. determination unit 17 may acquire the image deterioration information from the memory 18 and determine the moving direction based on the image deterioration information.

Further, the direction etc. determination unit 17 determines the changed amount of the still image portion, that is, the movement amount based on the motion vector of the moving image portion. That is, the direction etc. determination unit 17 extracts the motion vector of the moving image portion that configures the peripheral region of the still image portion, and calculates the arithmetic mean value of the motion vector. The direction etc. determination unit 17 then determines the movement amount of the still image portion to be the same value as the arithmetic mean value of the motion vector.

Further, when the luminance of the still image portion is larger than the predetermined luminance, the direction etc. determination unit 17 may determine the luminance to be a value that is a predetermined luminance or less. Accordingly, the burn-in can be reliably reduced. This processing may be performed irrespective of the stillness type of the input image.

Meanwhile, when the input image is the “partial region stillness”, the direction etc. determination unit 17 determines the changing direction of the still image portion, that is, the moving direction to be the x direction or the y direction. To be specific, when the still image portion is formed across the length between the both ends in the x direction, the direction etc. determination unit 17 determines the changing direction to be the y direction. Meanwhile, when the still image portion is formed across the length between the both ends in the y direction, the direction etc. determination unit 17 determines the changing direction to be the x direction. Here, the direction etc. determination unit 17 may acquire the image deterioration information from the memory 18 and determine the moving direction based on the image deterioration information.

Further, the direction etc. determination unit 17 determines the still changed amount of the image portion, that is, the movement amount based on the motion vector of the moving image portion. That is, the direction etc. determination unit 17 extracts the motion vector of the moving image portion that configures the peripheral region of the still image portion, and calculates the arithmetic mean value of the motion vector. The direction etc. determination unit 17 then determines the motion amount of the still image portion to be the same value as the arithmetic mean value of the motion vector.

Meanwhile, when the input image is the “whole region stillness”, the direction etc. determination unit 17 determines the changing direction and the changed amount of the still image portion, that is, the x component and the y component of the display magnification. The still image portion is enlarged into the x direction when the x component is larger than 1, and the still image portion is reduced in the x direction when the x component is a value of less than 1. The same applies to the y component. Here, the direction etc. determination unit 17 may acquire the image deterioration information from the memory 18 and determine the x component and the y component of the display magnification based on the image deterioration information.

The direction etc. determination unit 17 outputs the change information related to the changing method, the changing direction, and the changed amount to the stillness interpolation unit 19, the motion interpolation unit 20, and the scaling interpolation unit 21.

In step S14, the motion interpolation unit 20 acquires the input images of the current frame and the preceding and subsequent frames from the memory 11. The motion interpolation unit 20 then generates the blank corresponding portion or the adjusted moving image portion based on the input images of the current frame and the preceding and subsequent frames, and the information provided from the motion vector calculation unit 12 and the direction etc. determination unit 17. The motion interpolation unit 20 then outputs the moving image interpolation information related to the blank corresponding portion or the adjusted moving image portion to the composition unit 22.

Meanwhile, in step S15, the stillness interpolation unit 19 acquires the input image of the current frame from the memory 11, and generates the still interpolation image based on the input image of the current frame, and the information provided from the motion vector calculation unit 12 and the direction etc. determination unit 17. The stillness interpolation unit 19 outputs the still interpolation image to the composition unit 22.

Meanwhile, in step S16, the scaling interpolation unit 21 performs the processing of interpolating the blank portion that has not been interpolated by the motion interpolation unit 20. That is, the scaling interpolation unit 21 acquires the input image of the current frame from the memory 11, and further acquires the still interpolation image and the blank corresponding portion from the stillness interpolation unit 19 and the motion interpolation unit 20. The scaling interpolation unit 21 then superimposes the blank corresponding portion on the blank portion to generate the composite image. The scaling interpolation unit 21 then determines whether a gap is formed in the blank portion, and filters and scales the blank corresponding portion to fill the gap.

Further, when the patterns of the blank corresponding portion and the pattern around the blank portion are not connected, the scaling interpolation unit 21 performs the filtering processing at the boundary between the blank corresponding portion and the peripheral portion of the blank portion to blur the boundary. The scaling interpolation unit 21 then outputs the composite image adjusted by the above-described processing, that is, the adjusted image to the composition unit 22.

In step S17, the composition unit 22 combines the still interpolation image, the blank corresponding portion (or the adjusted moving image portion), and the adjusted image to generate the composite image. The composition unit 22 outputs the composite image to, for example, the display. The display displays the composite image.

As described above, according to the present embodiment, the image processing apparatus 10 can remain the display position of the whole input screen to be fixed by moving only the still image portion within the input image. Therefore, the user is less likely to feel that the display position has been moved. For example, the image processing apparatus 10 can move only characters of a clock display at a screen corner. Further, since only a part of the still image portion of the image processing apparatus 10 is moved compared with a case where the whole input image is moved, the movement of the still image portion is less likely to be noticed by the user. Accordingly, the image processing apparatus 10 can increase the changed amount of the still image portion, and increase a reduction amount of the burn-in. Further, since the image processing apparatus 10 can calculate the changing direction and the changed amount of the still image portion based on the image deterioration information, the deterioration of the elements can be uniformed throughout the screen, and unevenness can be reduced.

To be more specific, the image processing apparatus 10 extracts the still image portion from the input image, and changes the still image portion to generate a composite image. The image processing apparatus 10 then displays the composite image on the display. Accordingly, the image processing apparatus 10 can change the still image portion after fixing the display position of the whole displayed image. Therefore, the annoyance that the user feels and the burn-in of the display can be reduced. Further, since the pixel number of the display can be a similar extent to the pixel number of the displayed image, the image processing apparatus 10 can reduce the pixel number of the display. That is, in the technology in which the whole displayed image is moved within the display screen of the display, it is necessary to prepare a blank space for the movement of the displayed image (a blank space for orbit processing) in the display. However, in the present embodiment, it is not necessary to prepare such a black space.

Further, since the image processing apparatus 10 adjusts the peripheral region of the still image portion, the movement of the still image portion can be less noticeable by the user. Further, the image processing apparatus 10 can generate a composite image that brings less discomfort to the user.

Further, since the image processing apparatus 10 adjusts the peripheral region of the still image portion based on the moving region, the movement of the still image portion can be less noticeable by the user. In addition, the image processing apparatus 10 can generate a composite image that brings less discomfort to the user.

Further, since the image processing apparatus 10 interpolates the blank portion caused due to the change of the still image portion to adjust the peripheral region of the still image portion, the movement of the still image portion can be less noticeable by the user. In addition, the image processing apparatus 10 can generate a composite image that brings less discomfort to the user.

Further, the image processing apparatus 10 extracts the moving image portion from the input the image, and interpolates the blank portion based on the moving image portion, thereby generating a composite image that brings less discomfort to the user.

Further, the image processing apparatus 10 interpolates the blank portion based on the motion vector of the moving image portion, thereby generating a composite image that brings less discomfort to the user.

Further, the image processing apparatus 10 extracts the blank corresponding portion corresponding to the blank portion from another frame based on the motion vector of the moving image portion, and superimposes the blank corresponding portion on the blank portion to interpolate the blank portion. Therefore, the image processing apparatus 10 can generate a composite image that brings less discomfort to the user.

Further, the image processing apparatus 10 changes the still image portion in the same direction to the motion vector of the moving image portion, and extracts the blank corresponding portion from the preceding frame based on the motion vector of the moving image portion. Therefore, the image processing apparatus 10 can generate a composite image that brings less discomfort to the user.

Further, the image processing apparatus 10 changes the still image portion in the opposite direction to the motion vector of the moving image portion, and extracts the blank corresponding portion from the subsequent frame based on the motion vector of the moving image portion. Therefore, the image processing apparatus 10 can generate a composite image that brings less discomfort to the user.

Further, the image processing apparatus 10 changes the still image portion in the direction intersecting the motion vector of the moving image portion, and interpolates the blank portion based on the still image portion of the current frame. Therefore, the image processing apparatus 10 can generate a composite image that brings less discomfort to the user.

Further, the image processing apparatus 10 sets the changed amount of the still image portion based on the magnitude of the motion vector of the moving image portion, thereby generating a composite image that brings less discomfort to the user.

Further, the image processing apparatus 10 applies non-linear scaling to the moving image portion to adjust the peripheral region of the still image portion, thereby generating a composite image that brings less discomfort to the user.

Further, the image processing apparatus 10 compares the pixels that configure the current frame and the pixels that configure another frame to extract the still image portion, thereby more accurately extracting the still image portion.

Further, while extracting the moving image portion from the peripheral region of the still image portion in a unit of the first block, the image processing apparatus 10 extracts the moving image portion from the separated region separated from the still image portion in a unit of the second block that is larger than the first block. Therefore, the image processing apparatus 10 can more accurately extract the moving image portion, and can more accurately interpolate the blank portion.

Further, the image processing apparatus 10 changes the still image portion based on the input image, that is, the usages of the display element that displays the composite image, thereby reliably reducing the burn-in.

As described above, while favorable embodiments of the present disclosure have been described with reference to the appended drawings, the technical scope of the present disclosure is not limited by these embodiments. It should be understood by those skilled in the art that various modifications, combinations, sub-combinations and alterations may occur depending on design requirements and other factors insofar as they are within the scope of the appended claims or the equivalents thereof.

For example, while, in the above-described embodiment, the processing of the present embodiment has been described by exemplarily illustrating some input images, the input image is not limited to the above-described examples.

Note that configurations below also belong to the technical scope of the present disclosure:

(1) An image processing apparatus including a control unit configured to extract a still image portion from an input image, and to change the still image portion.
(2) The image processing apparatus according to (1), wherein the control unit adjusts a peripheral region of the still image portion.
(3) The image processing apparatus according to (2), wherein the control unit extracts a moving image portion from the input image, and adjusts the peripheral region of the still image portion based on the moving image portion.
(4) The image processing apparatus according to (3), wherein the control unit interpolates a blank portion caused due to change of the still image portion based on the moving image portion.
(5) The image processing apparatus according to (4), wherein the control unit interpolates the blank portion based on a motion vector of the moving image portion.
(6) The image processing apparatus according to (5), wherein the control unit extracts a blank corresponding portion corresponding to the blank portion from another frame based on the motion vector of the moving image portion, and superimposes the blank corresponding portion on the blank portion to interpolate the blank portion.
(7) The image processing apparatus according to (6), wherein the control unit changes the still image portion in a same direction as the motion vector of the moving image portion, and extracts the blank corresponding portion from a preceding frame based on the motion vector of the moving image portion.
(8) The image processing apparatus according to (6), wherein the control unit changes the still image portion in an opposite direction to the motion vector of the moving image portion, and extracts the blank corresponding portion from a subsequent frame based on the motion vector of the moving image portion.
(9) The image processing apparatus according to (5), wherein the control unit changes the still image portion in a direction intersecting the motion vector of the moving image portion, and interpolates the blank portion based on a still image portion of a current frame.
(10) The image processing apparatus according to any one of (3) to (9), wherein the control unit sets a changed amount of the still image portion based on a magnitude of the motion vector of the moving image portion.
(11) The image processing apparatus according to any one of (3) to (9), wherein the control unit applies non-linear scaling to the moving image portion to adjust the peripheral region of the still image portion.
(12) The image processing apparatus according to any one of (3) to (11), wherein the control unit extracts the moving image portion from the peripheral region of the still image portion in a unit of a first block, while extracting the moving image portion from a separated region separated from the still image portion in a unit of a second block that is wider than the first block.
(13) The image processing apparatus according to any one of (1) to (12), wherein the control unit compares a pixel configuring a current frame and a pixel configuring another frame to extract the still image portion for each pixel.
(14) The image processing apparatus according to any one of (1) to (13), wherein the control unit changes the still image portion based on usages of an element that displays the input image.
(15) An image processing method including extracting a still image portion from an input image, and changing the still image portion.
(16) A program for causing a computer to realize a control function to extract a still image portion from an input image, and to change the still image portion.

The present disclosure contains subject matter related to that disclosed in Japanese Priority Patent Application JP 2012-180833 filed in the Japan Patent Office on Aug. 17, 2012, the entire content of which is hereby incorporated by reference.

### REFERENCE SIGNS LIST

10 Image processing apparatus
11 Memory
12 Motion vector calculation unit
13 Pixel difference calculation unit
14 Moving portion detection unit
15 Still portion detection unit
16 Stillness type determination unit
17 Direction etc. determination unit
18 Memory
19 Stillness interpolation unit
20 Motion interpolation unit
21 Scaling interpolation unit
22 Composition unit

1. An image processing apparatus comprising:
a control unit configured to extract a still image portion from an input image, and to change the still image portion.

2. The image processing apparatus according to claim 1, wherein the control unit adjusts a peripheral region of the still image portion.

3. The image processing apparatus according to claim 2, wherein the control unit extracts a moving image portion from the input image, and adjusts the peripheral region of the still image portion based on the moving image portion.

4. The image processing apparatus according to claim 3, wherein the control unit interpolates a blank portion caused due to change of the still image portion based on the moving image portion.

5. The image processing apparatus according to claim 4, wherein the control unit interpolates the blank portion based on a motion vector of the moving image portion.

6. The image processing apparatus according to claim 5, wherein the control unit extracts a blank corresponding portion corresponding to the blank portion from another frame based on the motion vector of the moving image portion, and superimposes the blank corresponding portion on the blank portion to interpolate the blank portion.

7. The image processing apparatus according to claim 6, wherein the control unit changes the still image portion in a same direction as the motion vector of the moving image portion, and extracts the blank corresponding portion from a preceding frame based on the motion vector of the moving image portion.

8. The image processing apparatus according to claim 6, wherein the control unit changes the still image portion in an opposite direction to the motion vector of the moving image portion, and extracts the blank corresponding portion from a subsequent frame based on the motion vector of the moving image portion.

9. The image processing apparatus according to claim 5, wherein the control unit changes the still image portion in a direction intersecting the motion vector of the moving image portion, and interpolates the blank portion based on a still image portion of a current frame.

10. The image processing apparatus according to claim 3, wherein the control unit sets a changed amount of the still image portion based on a magnitude of the motion vector of the moving image portion.

11. The image processing apparatus according to claim 3, wherein the control unit applies non-linear scaling to the moving image portion to adjust the peripheral region of the still image portion.

12. The image processing apparatus according to claim 3, wherein the control unit extracts the moving image portion from the peripheral region of the still image portion in a unit of a first block, while extracting the moving image portion from a separated region separated from the still image portion in a unit of a second block that is wider than the first block.

13. The image processing apparatus according to claim 1, wherein the control unit compares a pixel configuring a current frame and a pixel configuring another frame to extract the still image portion for each pixel.

14. The image processing apparatus according to claim 1, wherein the control unit changes the still image portion based on usages of an element that displays the input image.

15. An image processing method comprising:
extracting a still image portion from an input image, and
changing the still image portion.

16. A program for causing a computer to realize:
a control function to extract a still image portion from an input image, and to change the still image portion.
